(19) United States
(12) Patent Application Publication
(10) Pub. No.: US 2025/0274714 A1
(43) Pub. Date: Aug. 28, 2025

(54) LOUDSPEAKER

(71) Applicant: PSS BELGIUM NV, Dendermonde (BE)

(72) Inventors: Jozef A.F. BAETEN, Dendermonde (BE); David CORYNEN, Dendermonde (BE)

(21) Appl. No.: 18/858,599

(22) PCT Filed: May 15, 2023
(86) PCT No.: PCT/EP2023/062984

§ 371 Date: Oct. 21, 2024

(30) Foreign Application Priority Data
May 17, 2022 (GB) 2207211.0

(51) Int. Cl. H04R 7/18; H04R 9/04

(52) U.S. Cl. CPC H04R 7/18; H04R 9/046

(57) ABSTRACT

A loudspeaker includes: a chassis, a diaphragm, a lead wire for supplying an electrical signal, a drive unit, and a stiffening element. The diaphragm is suspended from the chassis by suspension elements. The drive unit moves the diaphragm along a translational axis based on the electrical signal and comprises a magnet unit, a voice coil and a voice coil former. The stiffening element is a rigid component stiffens a portion of the diaphragm adjacent to the voice coil former. The stiffening element fits around the voice coil former and extends radially outwardly. The voice coil former includes a conductive strip for conducting the electrical signal from the lead wire to the voice coil. The voice coil is electrically connected to the conductive strip via a first landing surface, and the lead wire is electrically connected to the conductive strip via a second landing surface.

This application claims priority to GB2207211.0, filed 17 May 2022.

### FIELD OF THE INVENTION

The present invention relates to a loudspeaker.

### BACKGROUND

Traditional loudspeakers typically include a drive unit configured to move a diaphragm along a translational axis based on an electrical signal. A typical drive unit is an electromechanical drive unit that includes a magnet unit which is configured to produce a magnetic field in an air gap, and a voice coil attached to a voice coil former. The voice coil is configured to sit in the air gap when the diaphragm is at rest. When the loudspeaker is in use, the voice coil is energized (e.g. by having the electrical signal pass through it) to produce a magnetic field which interacts with the magnetic field produced by the magnet unit. This causes the voice coil (and therefore the diaphragm) to move relative to the magnet unit along the translational axis with force F=B*L*i such that the diaphragm radiates sound in both forward and rear directions parallel to the translational axis.

Shallow loudspeakers often include conical diaphragms wherein the conical shape provides strength to the diaphragm. WO2004/017674 discloses a loudspeaker with a conical diaphragm which is shallower owing to the addition of a stiffening element (referred to as a “bridging element” in WO2004/017674) which is connected to the voice coil former and the diaphragm.

The present inventor has observed that a stiffening element such the “bridging element” described in WO2004/017674 facilitates the implementation of shallower loudspeaker by stiffening a portion of the diaphragm adjacent to the voice coil former. In particular, the diaphragm can incorporate a flattened base portion adjacent to the voice coil former, which is stiffened by the stiffening element, thereby helping to achieve a shallower loudspeaker whilst avoiding compromising sound quality. Therefore, the overall height of loudspeaker can be reduced.

However, as described below in more detail, the present inventor has observed that loudspeaker designs with stiffening elements, such as in WO2004/017674, can be susceptible to manufacturing issues during assembly of the drive unit. This can affect the sound quality and production costs of the loudspeaker. For example, the present inventor has observed that the manufacture of loudspeakers with stiffening elements can result in a channel being formed between the stiffening element and the voice coil former through which water may penetrate. This is undesirable in open-air applications since such water penetration may affect the sound quality and potentially cause damage to the loudspeaker.

The present invention has been devised in light of the above considerations.

### SUMMARY OF THE INVENTION

Accordingly, a first aspect of the present invention provides:
a loudspeaker comprising:
a chassis;
a diaphragm suspended from the chassis by one or more suspension elements;
a lead wire for supplying an electrical signal;
a drive unit configured to move the diaphragm along a translational axis based on the electrical signal, the drive unit comprising a magnet unit, a voice coil and a voice coil former; and
a stiffening element which is a rigid component configured to stiffen a portion of the diaphragm adjacent to the voice coil former;
wherein:
   the stiffening element fits around the voice coil former and extends radially outwardly from the voice coil former with respect to the translational axis;
   the voice coil former includes a conductive strip for conducting the electrical signal from the lead wire to the voice coil; and
   the voice coil is electrically connected to the conductive strip via a first landing surface on the conductive strip, and the lead wire is electrically connected to the conductive strip via a second landing surface on the conductive strip, wherein the first and second landing surfaces are located on opposite sides of the stiffening element with respect to the translational axis.

Advantageously, the conductive strip being located on the voice coil former allows the stiffening element to be fit more snugly around the voice coil former (i.e. with smaller gap between stiffening element and voice coil former). This is possible because the conductive strip can be thinner than the wires used to electrically connect the lead wire and the voice coil in conventional loudspeakers. Whereas in conventional loudspeakers with stiffening elements, the stiffening element must be significantly larger than the voice coil former in order to accommodate the presence of such wires running between the voice coil former and the stiffening element.

By fitting the stiffening element closer to the voice coil former, the likelihood of glue dripping down into the magnet assembly when the stiffening element is glued to voice coil former can be reduced. Therefore, the likelihood of mechanical noises (known in the industry as ‘hard bottoming sounds’) being produced when the loudspeaker is in use can be reduced, thereby improving the overall sound quality of the loudspeaker. Furthermore, water ingress can also be reduced for reasons discussed below. Moreover, using a conductive strip (instead of the more vulnerable, insulated wires typically used in conventional loudspeakers) helps to reduce the likelihood of damage to the electrical connection between the lead wire and voice coil former during assembly.

Advantageously, a loudspeaker according to the first aspect is also less susceptible to manufacturing issues during assembly for reasons discussed in more detail below.

The drive unit may be an electromagnetic drive unit that includes a magnet unit configured to produce a magnetic field in an air gap, and a voice coil attached to the diaphragm, wherein the voice coil is configured to sit in the air gap when the diaphragm is at rest. When the loudspeaker is in use, the voice coil may be energized (e.g. by having the electrical signal pass through it) to produce a magnetic field which interacts with the magnetic field produced by the magnet unit and which causes the voice coil (and therefore the diaphragm) to move along a movement axis relative to the magnet unit. Such drive units are well known.

Because the stiffening element is rigid and is attached to the diaphragm adjacent to the voice coil former, it can serve to stiffen the diaphragm adjacent to the voice coil former, thereby helping to maintain the stiffness of the diaphragm whilst allowing the diaphragm to have a shallower depth in the axial direction.

The portion of the diaphragm adjacent to the voice coil former may be referred to as a base portion of the diaphragm. The diaphragm may include a conical portion located radially outwardly of the base portion. The base portion of the diaphragm may be flattened relative to the conical portion in the direction of the translational axis (e.g. the base portion may have an extent in the direction of the translational axis which is less than the conical portion), in which case the diaphragm may be referred to as having a dished profile. The base portion may be flat or substantially flat, relative to the translational axis.

The rigid stiffening element may be directly attached to both the diaphragm and the voice coil former (e.g. as shown in FIG. 1), since helps to stiffen the connection between the diaphragm and the voice coil former (since the diaphragm and voice coil former preferably move substantially together, i.e. “as one”, when the loudspeaker is in use). However, arrangements can be envisaged in which, for example, the stiffening element is directly attached to diaphragm but not the voice coil former, yet the diaphragm and voice coil former are configured to still move together (i.e. “as one”) through a direct attachment between the diaphragm and voice former.

The conductive strip may be a portion of conductive material that has a width in a circumferential direction (relative to the translational axis) that is larger than a thickness in a radial direction (relative to the translational axis). The conductive strip may have a generally flat rectangular shape (which may be adapted to curvature of voice coil former) or be any other shape which extends along the translational axis from the first landing surface to the second landing surface.

In some examples, the conductive strip may be located on (e.g. attached to) the voice coil former. The conductive strip may be located on (e.g. attached to) a radially outwardly facing surface of the voice coil former. The conductive strip may be located on (e.g. attached to) an inwardly facing surface of the voice coil former. The conductive strip may be attached to a radially outwardly facing surface of the voice coil former, e.g. by glue. The glue may be a thermosetting glue. Alternatively, any other mechanical means may be used to attach the conductive strip to the voice coil former.

In some other examples, the conductive strip may be embedded in the voice coil former such that the conductive strip is flush with or recessed from a radially outwardly facing surface of the voice coil former.

The conductive strip may be a portion of conductive (e.g. metal) foil, located on (e.g. attached to) the voice coil former. In other examples, the conductive strip may be a conductive pad, a conductive glue, or a conductive spray. The conductive strip may e.g. be attached to a radially outwardly facing surface of the voice coil former. The conductive foil may be a copper foil. However, the conductive strip may be made from any electrically conductive material. For example, the conductive strip may also be made from aluminium, gold, nickel, silver, or a conductive alloy.

The first and/or second landing surface may be a region of the conductive strip for electrically connecting to voice coil and/or lead wire respectively. Preferably, the conductive strip is a single piece of material (for example a single piece of foil) and the first and/or second landing surface are part of that single piece of material. However, in some examples, the first and/or second landing surface may be made of a different material to the remainder of the conductive strip. For example, the first and/or second landing surfaces may include a solder pad made of a conductive metal which is different to the remainder of the conductive strip. In some examples, the first and/or second landing surfaces may include a mechanical formation for making a mechanical connection to the voice coil and/or lead wire respectively. In some examples, the first and/or second landing surface may be pre-tinned with solder in preparation for making a solder connection to the voice coil and/or lead wire respectively.

The conductive strip may protrude less than 0.5 mm from a radially outwardly facing surface of the voice coil former (herein, “radially outwardly facing” may mean radially outward with respect to the translational axis). More preferably the conductive strip protrudes less than 0.3 mm, or more preferably less than 0.1 mm from the radially outwardly facing surface.

The distance between the first landing surface and the second landing surface may be at least 20% of the total height of the voice coil former measured along the translational axis. In some examples, this distance, may be, for example, 20%, 30%, 40%, 50%, 60%, 70% or 80%.

This may help the stiffening element to be positioned between the first and second landing surfaces without interfering with the electrical connections between the voice coil and the first landing surface, and the lead wire and the second landing surface. However, other % values are possible, e.g. if the voice coil has a short height and the voice coil former is tall as measured along the translational axis.

An outlet wire of the voice coil may be soldered to the first landing surface of the conductive strip. Alternatively, the voice coil may be electrically connected to the first landing surface by another means such as a mechanical connection or a conductive glue.

The lead wire may be soldered to the second landing surface of the conductive strip. Alternatively, the lead wire may be electrically connected to the second landing surface by another means such as a mechanical connection or a conductive glue.

Having separate landing surfaces for each electrical connection can aid with assembly of the loudspeaker. For example, when the voice coil is soldered to the first landing surface on the conductive strip the lead wire can then also be soldered to the second landing surface on the conductive strip at a later time without risking de-soldering of the first solder connection between the voice coil and the conductive strip.

The voice coil may be soldered to the first landing surface with a first solder material and the lead wire may be soldered to the second landing surface with a second solder material.

The presence of first and second landing surfaces means that incompatible (different) soldering materials may be used for each electrical connection without jeopardising the mechanical integrity of the connections. This can reduce production costs and increase the range of usable materials which the voice coil and lead wires may be made from. For example, in some embodiments a specific solder flux designed for soldering aluminium wire may be used to electrically connect the voice coil to the first landing surface and a second soldering flux for soldering standard copper wire may be used to solder the lead wire to the second landing surface.

The voice coil may in some examples be made of one of copper, copper clad aluminium or aluminium. Other conductive materials may also be used. Copper can be less expensive whereas aluminium offers weight saving benefits.

The stiffening element may be made from metal. Preferably the stiffening element may be made from aluminium. Making the stiffening element from metal can be less expensive than other materials and aluminium is particularly preferred because it is lightweight.

The stiffening element may be made from an anodized metal. More preferably the stiffening element may be made from anodized aluminium. Conveniently, the anodized surface of the stiffening element is not electrically conductive resulting in less chance of damage to the loudspeaker from the stiffening element creating short circuits.

In other examples the stiffening element may be made from a polymer with stiffening ribs. For example, the stiffening element may be made from PC, PCABS, PCGF, PPGF or any other polymer material combinations. A stiffening element made from a polymer may be lightweight and is not electrically conductive. Therefore, there is less chance of damage to the loudspeaker due to the stiffening element creating short circuits between conductive strips, lead wires, or voice coil inputs and outputs.

The conductive strip may be partially covered by an insulating material. The insulating material may be attached to the voice coil former. The insulating material preferably leaves the first and second landing surfaces exposed, i.e. does not cover the first and second landing surfaces.

By covering the conductive strip in an insulating material the electrical connections between the lead wire(s) and voice coil are protected from short circuits caused by contact with the stiffening element—even when the stiffening element is made of a conductive material.

The insulating material may be smaller than the conductive strip along the translational axis and cover a region of the conductive strip between the first and second landing surfaces. In other examples, the insulating material may be larger along the translational axis than the distance between first and second landing surfaces and include openings over the first and second landing surfaces.

When the conductive strip is covered by an insulating material, a surface of the stiffening element which faces towards the voice coil former may be electrically conductive. For example, the stiffening element may be made from an anodized metal disc which is then stamped to create an opening whose (un-anodized) inwardly facing surface is configured to receive the voice coil former. Forming the stiffening element in this order (by anodizing the metal first) can be cheaper than if a fully formed stiffening element (already stamped to include an opening) were anodized.

The conductive strip and the insulating material may be made from a PCB (printed circuit board) or a flexi-PCB (flexible PCB) which has exposed pads at the first and second landing surfaces.

The stiffening element may have an interior cut-out which corresponds to the shape of the voice coil former such that the stiffening element fits around the voice coil former. For example, the voice coil former may be cylindrical with a circular cross-section (as taken perpendicular to the translational axis) and the stiffening element has a circular interior opening. In alternative embodiments the voice coil former may have an ovular, square, rectangular or any other shaped cross-section.

The stiffening element may be glued to the voice coil former. The glue may be a thermosetting glue. The glue may be a “one component glue” or a “two component glue” (which may also be referred to as an “AB glue”). The two component glue may include an A component which is a resin and a B component which functions as a hardener.

The distance between an outer surface of the voice coil former and an inner surface of the stiffening element may, at its largest extent, be no more than 0.5 mm, more preferably no more than 0.2 mm, more preferably no more than 0.1 mm. This reduces the risk of glue dripping down into the remainder of the loudspeaker during assembly of the stiffening element and the voice coil former. Achieving a small clearance between the stiffening element and voice coil former is particularly beneficial in examples where the stiffening element becomes asymmetrically positioned relative to the voice coil former (in the radial direction) during assembly which may result in a larger distance between the stiffening element and voice coil former on one side which could allow glue to drip down into the remainder of the loudspeaker.

The above-recited lead wire may be a first lead wire for supplying a first electrical signal and the above-recited conductive strip may be a first conductive strip for conducting the first electrical signal to the voice coil.

The loudspeaker may additionally comprise a second lead wire for supplying a second electrical signal and a second conductive strip for conducting the second electrical signal to the voice coil. The second lead wire and second conductive strip may have features as described above with respect to the first lead wire and first conductive strip.

Thus, the voice coil may be electrically connected to the second conductive strip via a first landing surface on the second conductive strip, and the second lead wire may be electrically connected to the second conductive strip via a second landing surface on the second conductive strip, wherein the first and second landing surfaces of the second conductive strip are located on opposite sides of the stiffening element with respect to the translational axis.

The presence of first and second lead wires and first and second conductive strips may help the loudspeaker to accommodate different power configurations for the voice coil, e.g. they may carry opposite polarities of the same electrical signal.

Additional pairs of lead wires and conductive strips are possible.

In general, lead wires are provided in multiples of two, e.g. a loudspeaker may include two lead wires, four lead wires, or six lead wires, etc. The/each pair of lead wires is configured to supply an electrical signal to a respective voice coil included in the loudspeaker.

However, it is worth noting that a benefit can be derived even if just one lead wire and conductive strip is used in accordance with the invention.

Any feature recited above in relation to the first lead wire and the first conductive strip may also apply to any additional lead wire and corresponding conductive strip.

A second aspect of the present invention may provide a method of forming a loudspeaker according to the first aspect.

The method may comprise:
electrically connecting the voice coil to the first landing surface of the conductive strip;
sliding the stiffening element over the voice coil former;
attaching the stiffening element to the diaphragm and voice coil former; and
attaching the lead wire to the second landing surface of the conductive strip;
wherein the stiffening element is attached to the voice coil former at a location along the translational axis that is between the first and second landing surfaces.

The step of electrically connecting the voice coil to the first landing surface may comprise attaching (e.g. by soldering) an outlet wire from the voice coil to the first landing surface

The step of electrically connecting the voice coil to the first landing surface may comprise soldering an outlet wire from the voice coil to the first landing surface using a first solder material and the step of attaching the lead wire to the second landing surface may comprise soldering the lead wire to the second landing surface using a second solder material.

The method may also comprise an initial step of forming the stiffening element.

Forming the stiffening element may include forming an opening in a disc-shaped element, e.g. by stamping. The disc-shaped element may be a disc of metal, e.g. of anodized aluminium. However, the stiffening element may be formed of any of the materials described in relation to the first aspect.

The method may additionally include electrically connecting the voice coil to a first landing surface of a second conductive strip, e.g. by attaching (e.g. soldering) a (second) outlet wire from the voice coil to the first landing surface of a second conductive strip.

The method may additionally include attaching a second lead wire to a second landing surface of the second conductive strip, e.g. by soldering the second lead wire to the second landing surface using of the second conductive strip. The first and second landing surfaces of the second conductive strip may be located on opposite sides of the stiffening element with respect to the translational axis.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a cross section view of a loudspeaker with a stiffening element made by the applicant in accordance with conventional principles;

FIG. 2a shows an exploded perspective view of a loudspeaker with a bridging element made by the applicant in accordance with conventional principles;

FIG. 2b shows a perspective view of the assembled loudspeaker of FIG. 2a;

FIG. 3 shows a diagram of a voice coil, voice coil former, and stiffening element configuration of a conventional loudspeaker;

FIG. 4a shows a cross section view of apparatus for testing water penetration of a loudspeaker;

FIG. 4b shows a picture of part of a conventional loudspeaker being tested with the apparatus of FIG. 4a;

FIG. 4c shows a top view of a voice coil former of a conventional loudspeaker along section A-A of FIG. 4b;

FIG. 5a shows a diagram a loudspeaker according to the present invention;

FIG. 5b shows a diagram of part of the loudspeaker of FIG. 5a.;

FIG. 6a shows a photograph of a voice coil, and voice coil former according to the present invention;

FIG. 6b shows a photograph of the voice coil, and voice coil former of FIG. 7a with a bridging element attached according to the present invention;

FIG. 7 shows a photograph of a loudspeaker according to the present invention;

FIG. 8a shows a top view of a voice coil former of a conventional loudspeaker; and

FIG. 8b shows a top view of a voice coil former according to the present invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

In the examples that follow, alike features have been given corresponding reference numerals, and corresponding descriptions may apply except where such a description is clearly impermissible or expressly avoided.

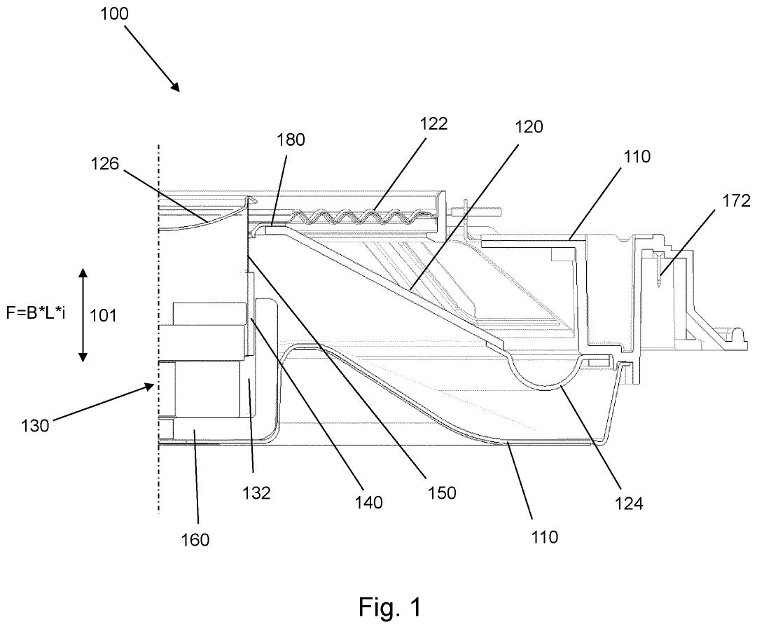

FIG. 1 shows a cross section view of a loudspeaker 100 with a stiffening element 180 made by the applicant in accordance with conventional principles. The loudspeaker 100 of FIG. 1 may be understood as an optimized version of a loudspeaker implementing the principles of the loudspeaker described in WO2004017674.

The loudspeaker 100 comprises a chassis 110, a diaphragm 120, a lead wire (not shown), a drive unit 130, and a rigid stiffening element 180.

The diaphragm 120 is suspended from the chassis 110 by suspension elements. In this example, the diaphragm 120 is a cone suspended by two suspension elements including a damper 122 (which may also be referred to as a “spider”) and a surround 124 (which may also be referred to as a “roll suspension” or “roll edge”).

The lead wire supplies an electrical signal to the drive unit 130 from an input jack 172. Typically, the loudspeaker may include two or more lead wires configured to supply positive and negative electrical signals to the drive unit 130. In this example, the lead wires are integrated inside the damper 122.

The drive unit 130 is configured to move the diaphragm 120 along a translational axis 101 based on the electrical signal and comprises a magnet unit 160, a voice coil 140 and a voice coil former 150.

The stiffening element 180 attaches to both the voice coil former 150 and the diaphragm 120 and extends radially outwardly from the voice coil former 150 with respect to the translational axis 101 (which may also be referred to herein as the “axial direction” or “movement axis”).

In this example, the drive unit 130 is an electromechanical drive unit that includes a magnet unit 160, which is configured to produce a magnetic field in an air gap 132, and a voice coil 140 which is attached to a voice coil former 150. The voice coil 140 is configured to sit in the air gap 132 when the diaphragm 120 is at rest. When the loudspeaker 100 is in use, the voice coil 140 is energized (e.g. by having the electrical signal pass through it) to produce a magnetic field which interacts with the magnetic field produced by the magnet unit 160. This causes the voice coil 140 (and therefore the stiffening element 180 and diaphragm 120) to move relative to the magnet unit 160 along the translational axis 101 with force F=B*L*i such that the diaphragm 120 radiates sound in both forward and rear directions parallel to the translational axis 101.

The voice coil 140 receives the electrical signal from the lead wire via additional lengths of wire (not shown) which pass between the voice coil former 150 and the stiffening element 180 to the voice coil 140. The voice coil former 150 may be covered in an insulating material (not shown).

A dust cap 126 is attached to the voice coil former 150 in front of the diaphragm 120, with respect the translational axis 101, to prevent dust or other foreign particles from getting into the drive unit.

As described in WO2004017674 the rigid stiffening element 180 (which is referred to in WO2004017674 as a bridging element) helps the height of the diaphragm 120 be reduced by stiffening the base part of the diaphragm 120 that connects to the voice coil former 150. The stiffening element 180 is rigidly connected to the voice coil former 150 so that the movement of the voice coil 140 and voice coil former 150 in the air gap 132 is translated directly to the diaphragm 120 (and smoothed by the suspension elements comprising the damper 122 and surround 124).

In this example, the voice coil former 150 is cylindrical and the stiffening element 180 is a disc comprising a circular opening for fitting around the voice coil former 150 (the opening may also be referred to herein as a “cut-out”). However, other shapes of voice coil former 150 and stiffening element opening are possible.

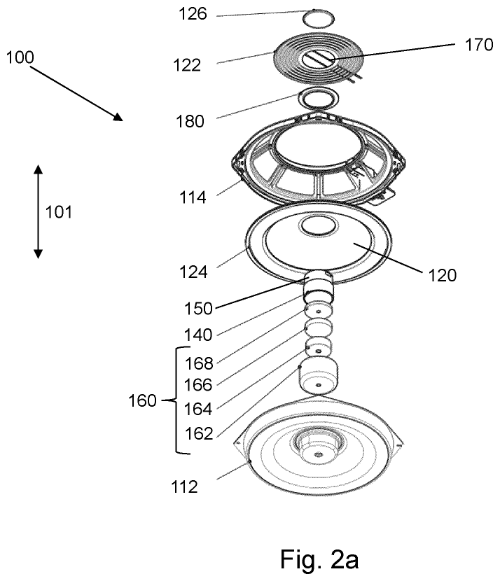

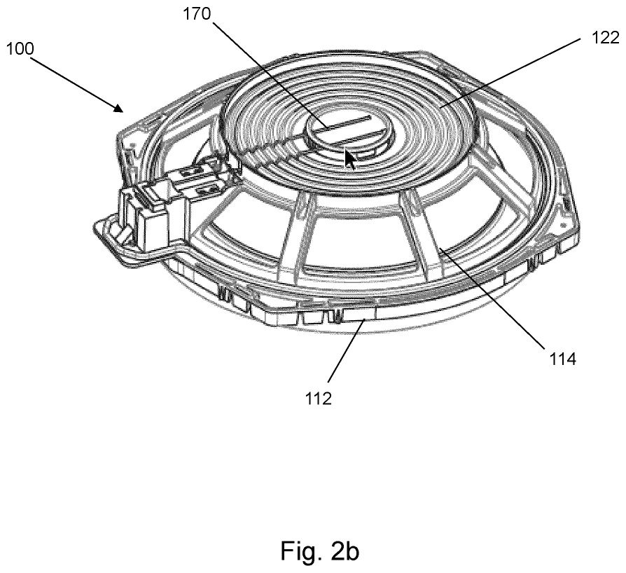

FIG. 2a shows an exploded perspective view of a loudspeaker 100 with a stiffening element 180 made by the applicant in accordance with conventional principles.

The loudspeaker 100 of FIG. 2a is typically assembled in mass production facilities by stacking the components as shown in the axial direction 101.

First, the magnet unit 160 which, in this example, comprises a yoke 161, spacer 164, magnet 166, and washer 168 is assembled and pressed into a metal basket 112. Next, the diaphragm 120, which is integrated with a surround 114, is then glued to a polymer basket 114. This assembly, comprising the diaphragm 120, surround 124 and polymer basket 114, is then combined with the previously assembled metal basket 112 and magnet unit assembly 160. The polymer basket 114 and metal basket 112 form the chassis 110 mentioned above for FIG. 1.

Next, the voice coil 140 and voice coil former 150 are placed on a production centering jig (not shown) and positioned in the magnet unit 160 so that the voice coil 140 is positioned correctly in the air gap of the magnet unit 160. The voice coil former 150 is now the highest point in the part-assembled loudspeaker 100 as seen in the axial direction. In this example, the voice coil 140 is provided with outlet wires pre-soldered to solder pads provided on the voice coil former 150.

Next, the stiffening element 180 is slid over the top of the voice coil former 150 until it is positioned part way between the top edge of the voice coil former 150 and the voice coil 140 below. Typically, the stiffening element 180 is then glued to the diaphragm 120 and the voice coil former 150 using a thermosetting glue. Glue is also used to attach the damper 122 to the stiffening element 180 and to the polymer basket 114. Other types of glue may instead be used to attach the stiffening element 180 to the diaphragm 120, for example a one component glue or a two component glue.

In this example, two lead wires 170 are integrated in the damper. An operator solders the ends of the lead wires 170 to soldering pads present on the voice coil former 150.

The final step is to place and glue the dust cap 126 onto the voice coil former 150.

FIG. 2b shows a perspective view of the assembled loudspeaker 100 of FIG. 2a.

To support this typical assembly method, the stiffening element 180 must be built with sufficient clearance to easily slide over the voice coil former 150.

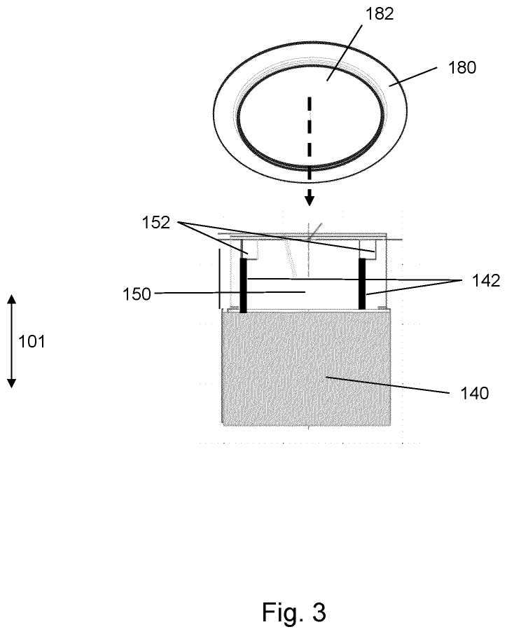

FIG. 3 shows a diagram of an example voice coil 140, voice coil former 150, and stiffening element 180 configuration that may be supplied for assembly of a loudspeaker made in accordance with conventional principles such as the loudspeaker shown in FIGS. 2a and 2b.

The voice coil 140 comprising N windings of wire is attached to the voice coil former 150 by soldering outlet wires 142 of the voice coil 140 to pre-tinned solder pads 152 which are provided on the voice coil former 150. The outlet wires 142 of the voice coil 140 are typically supplied glued to an outer surface of the voice coil former 150 and are pre-soldered to the solder pads 152 in preparation for the assembly process described for FIG. 2a. The stiffening element 180 has a cut-out 182 provided in preparation for fitting the stiffening element 180 over the voice coil former 150.

During assembly of the loudspeaker, the voice coil 140 is positioned in the loudspeaker on a centering jig, as described above, and the stiffening element 180 is then fit over the voice coil former 150 and attached to the voice coil former 150 at a position below the solder pads 152. Lead wires (not shown) would then typically be soldered directly to the same solder pads 152 as the outlet wires 142 of the voice coil 140.

Accordingly, the cut-out in the stiffening element 180 must be made big enough to fit over the voice coil former 150, and the outlet wires 142 of the voice coil 140, and the existing solder connections between the outlet wires 142 of the voice coil 140 and the solder pads 152. The present inventor has observed that this larger cut-out can cause manufacturing difficulties when the stiffening element 180 is attached to the voice coil former 150 using glue. This is because the glue can drop down into the resulting space between the stiffening element 180 and the voice coil former 140 from where the glue may drip into the air gap of the magnet unit.

The present inventor has observed that glue which has dripped into the air gap can be detected in end of line sweeps wherein the finished loudspeaker is connected to a source and tested at a high excursion. Glue which has dropped into the magnet unit can reduce the mechanical excursion of the loudspeaker which can noticeably reduce the resulting sound quality and cause mechanical noises which are referred to in the industry as “hard bottoming sounds”. Operators have no visible control of this issue when they are assembling the loudspeaker because the drive unit of an assembled loudspeaker is enclosed by the diaphragm and the stiffening element 180. The typical high temperatures found in production environments can worsen this issue by reducing the viscosity of the glue making it more likely to drip.

In addition, the process of soldering the lead wires to the same solder pads 152 as the outlet wires 142 of the voice coil 140 can make assembly of the loudspeaker difficult and inefficient because the process of soldering the lead wires to the solder pads 152 can melt the existing solder and cause the existing connections between the outlet wires 142 of the voice coil 140 and the solder pads 152 to de-solder.

The winding wire of the voice coil 140 may be made of any conductive metal. However, traditionally copper wire is used. When the voice coil 140 is made of copper wire the outlet wires 142 of the voice coil 140 and the lead wires may be soldered to the solder pads 152 using a typical tin solder and solder flux.

However, in some examples the winding wire of the voice coil 140 may preferably be made of aluminium or copper clad aluminium to save weight (this is particularly preferable for open air applications as described below). In these examples, a specific soldering flux for pure aluminium wire may be used to solder the outlet wires 142 of the voice coil 140 to the solder pads 152. However, the present inventor has observed that this pure aluminium compatible solder flux is incompatible with the copper solder flux typically used to solder the lead wires to the solder pads 152. As a result of the incompatible solder fluxes being used together, mechanical failures have been observed by the present inventor during validation tests of the assembled loudspeakers.

Loudspeakers with stiffening elements, particularly subwoofers, are increasingly being used in open-air applications (which may also be referred to herein as “fresh air” of “full 2-pi” applications). In most traditional applications, subwoofers are contained in boxes to prevent acoustical short circuits between sound being radiated in a forward direction from the loudspeaker diaphragm and sound being radiated in a backwards direction from the loudspeaker diaphragm. However, in open air applications, the loudspeaker is not contained in a box.

For example, this is particularly popular in the automotive industry where, to reduce costs, a vehicle body may be used as a baffle to separate the sound being radiated in the forward direction from the sound being radiated in the backwards direction.

In these full 2pi-applications, there is no enclosed air present behind the loudspeaker. Therefore, Qts=Qtc (where Qts is the total damping factor of a loudspeaker in free air and Qtc is the total damping factor of a speaker which loudspeaker when it is mounted in an enclosure) and Fs=Fc (where Fs is the resonant frequency of a loudspeaker in free air and Fc is the resonant frequency of a loudspeaker when it is mounted in an enclosure). As a result, good acoustical performance can be achieved with a lower force-factor for the magnet system (BL). This means the loudspeakers can be made more cheaply. However, to implement a loudspeaker with a lower force-factor it is preferable for the moving mass of the loudspeaker to be as low as possible.

Depending on the electrical resistance of the voice coil, the winding height of the voice coil, the number of winding layers, and the winding wire material, the voice coil can become the dominant moving mass in a loudspeaker. This is particularly true for subwoofers with long excursions. Therefore, it is particularly desirable to make the voice coil in loudspeakers being used for open air applications from aluminium or copper clad aluminium wire as opposed to pure copper wire. However, the use of aluminium or copper clad aluminium wire can lead to issues resulting from the use of incompatible soldering methods as described above. Furthermore, the present inventor has observed that pure aluminium wire and copper-clad aluminium wire is more susceptible to corrosion when it is exposed to water which can shorten the lifetime of the loudspeaker.

In open-air applications, it is preferable for the loudspeaker to have a dry zone and a wet zone. The magnet unit of the loudspeaker should be in the dry zone (for example inside the body of a vehicle) and the back parts of the loudspeaker (for example including the spider and dust cap and back face of the diaphragm) should be in the wet zone (or outside the interior environment of the vehicle). Water should not be able to penetrate the loudspeaker from the wet zone to the dry zone. Therefore, loudspeakers for open-air applications are often required to pass tests for testing the water penetration of the loudspeaker.

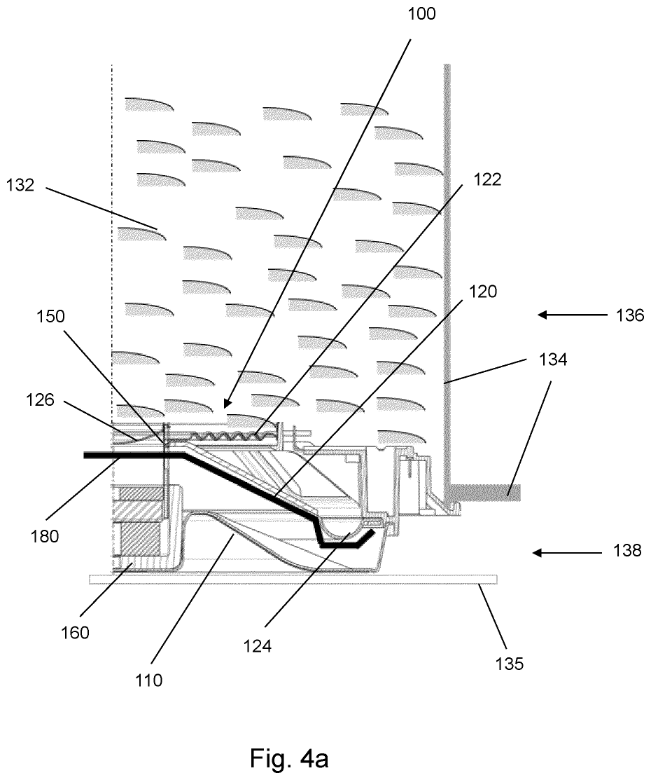

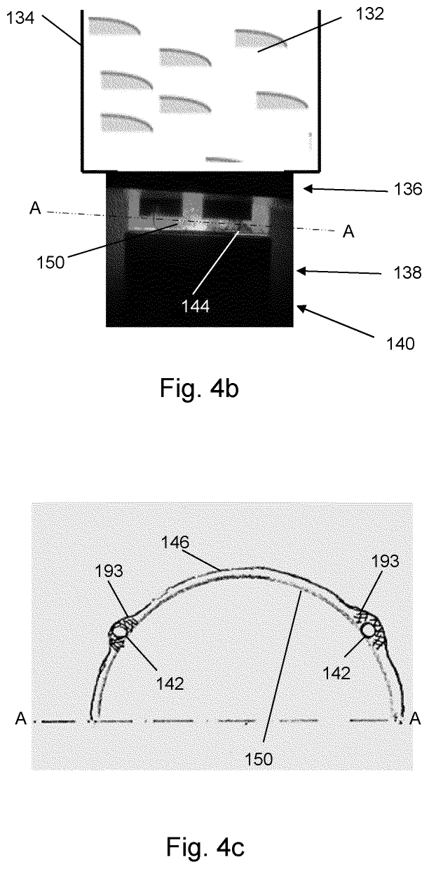

FIG. 4a shows a cross section view of apparatus which may be used to test the water penetration of a loudspeaker.

A loudspeaker under test 100 is mounted inside a vertical tube 134 or column so that the back of the loudspeaker 100 (comprising the magnet unit 160 and base part of the chassis 110) is at the bottom and the front of the loudspeaker 100 (comprising the damper 122 and dust cap 126) is at the top. The vertical tube 134 is then filled with water 132 to test the water penetration of the loudspeaker under test 100.

The height of the water 132 above the loudspeaker under test 100 may vary from 100 mm to 1000 mm depending on the required validation requirements. This water 132 creates high static force on the soft parts of the loudspeaker under test 100 comprising the fibrous damper 122, dust cap 126, voice coil former 150, outlet wires (not shown) of the voice coil which are covered by an insulating paper (not shown), the diaphragm 120, and the soft surround 124. These components represent a separation barrier between a desired dry zone 138 of the loudspeaker 100 which is below these components, and a wet zone 136 which is above these components.

A mirror 135 is positioned below the loudspeaker under test 100 to detect any water which has passed through. The water 132 is left for a defined amount of time (for example 1 hour, or for up to 24 hours) to potentially penetrate the loudspeaker 100 from the wet zone 136 to the dry zone 138. If water drops are detected on the mirror 135 after the defined amount of time, then the loudspeaker 100 has failed the test. The present inventor has observed that loudspeakers with stiffening elements made in accordance with conventional principles failed this test.

FIG. 4b shows a picture of part of a conventional loudspeaker being tested with the apparatus of FIG. 4a.

To visualize the path of water leakage, part of a loudspeaker including a voice coil 140, voice coil former 150, dust cap 136, and a stiffening element 180 glued to the voice coil former 150 was mounted inside a clear PVC-tube 134. The clear PVC tube 134 was filled with black coloured water 132 and a high-power LED was mounted inside the voice coil former 150 to allow water leaking from the wet zone 136 to the dry zone 138 to be seen.

A shadowed section 144 visible in FIG. 4b represents a path taken by leaking water along the voice coil former 150 towards the voice coil 140. The present inventor believes from this data that water is able to penetrate the conventional loudspeaker via capillary action through an area between the insulating paper and the voice coil former 150 around the outlet wires of the voice coil 140. This is explained in more detail below.

FIG. 4c shows a top view of a voice coil former 150 from a conventional loudspeaker taken along section A-A of FIG. 4b.

Outlet wires 142 of the voice coil run between the voice coil former 150 and the stiffening element as described above for FIG. 3. An insulating paper 146 covers the voice coil former 150 and the outlet wires 142. The voice coil former 150 is made of aluminium, Kapton, glass fibre, Kevlar, or any other appropriate material and the outlet wires 152 of the voice coil are glued to the voice coil former 150 using a thermosetting glue. The insulating paper 146 is glued to the voice coil former 150 over the outlet wires 146 which are soldered to pre-tinned soldering pads (not shown).

The winding wire of the voice coil which extends into the outlet wires 142 may vary in thickness from 0.2 mm to 0.8 mm. The insulating paper 146 typically has a thickness of 0.05 mm to 0.15 mm. Therefore, it can be very difficult or even impossible for the insulating paper 146 to perfectly lie flush with the outer diameter of the outlet wires 142 without creating free channels or openings 193 (represented by the hatched sections of FIG. 4c) around the outlet wires 142. These free channels or openings 193 combined with the static pressure of the water 132 in the PVC tube 134 allow water to leak from the wet zone to the dry zone using capillary action through the free channels 193 surrounding the outlet wires 142 of the voice coil. This water leakage is an undesirable aspect of loudspeakers which are intended for use in open air applications.

The present invention has been devised in light of the above considerations.

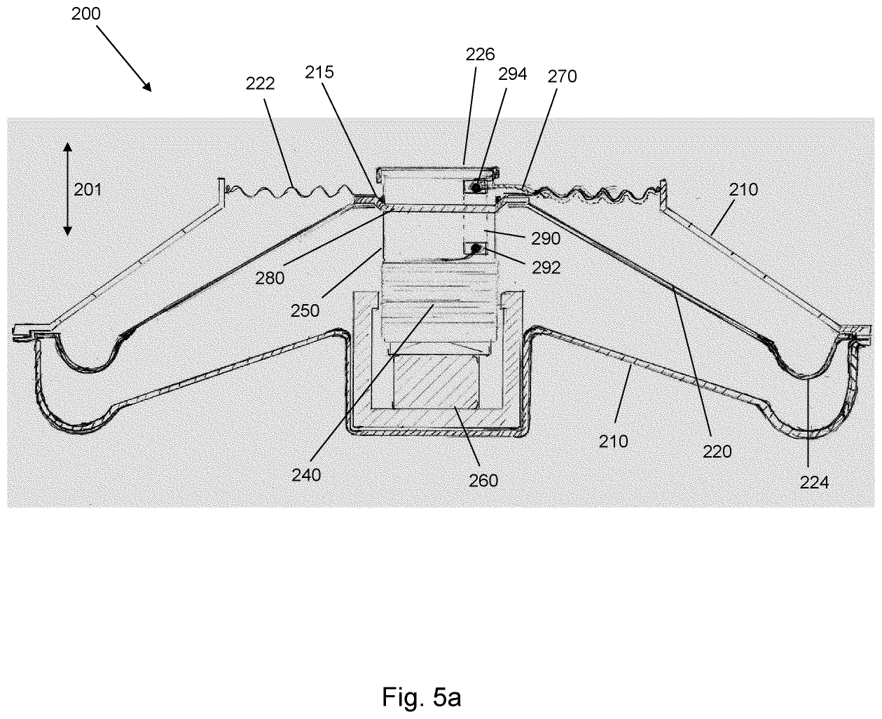

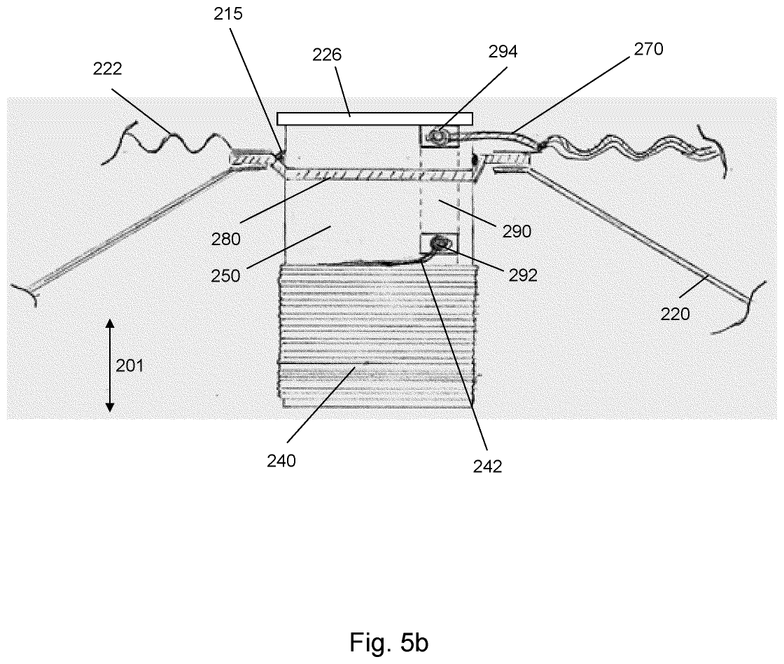

FIG. 5a shows a diagram of a loudspeaker according to the present invention showing a voice coil 240, voice coil former 250, stiffening element 280 and diaphragm 220. FIG. 5b shows a diagram of part of a loudspeaker according to the present invention showing the voice coil 240, voice coil former 250, stiffening element 280, and diaphragm 220 of FIG. 5a.

The diaphragm 220 is suspended from a chassis 210 by one or more suspension elements. In this example, a damper 222 is attached to the stiffening element 280 which is in turn attached to the diaphragm 220 such that a base part of the diaphragm 220 is suspended from the chassis 210. A surround 224 suspends the outer part of the diaphragm 220 from the chassis 210.

A lead wire 270 is provided to supply an electrical signal.

A drive unit 260 is configured to move the diaphragm 220 along a translational axis 201 based on the electrical signal. The drive unit 260 comprises a magnet unit, the voice coil 240 and the voice coil former 250. The drive unit 260 is an electromechanical drive unit as described above for FIG. 1.

The stiffening element 280 is rigid and attaches to both the voice coil former 250 and the diaphragm 220. The stiffening element 280 extends radially outwardly from the voice coil former 250 with respect to the translational axis 201 and may be made from metal, such as aluminium or anodized aluminium, or from a polymer with stiffening ribs.

The voice coil former 250 includes a conductive strip 290 for conducting the electrical signal from the lead wire 270 to the voice coil 240. The voice coil 240 is electrically connected to the conductive strip 290 via a first landing surface 292 on the conductive strip 290, and the lead wire 270 is electrically connected to the conductive strip 290 via a second landing surface 294 on the conductive strip 290. The first and second landing surfaces 292, 294 are located on opposite sides of the stiffening element 280 with respect to the translational axis 201.

A dust cap 226 is provided to prevent dust or other foreign particles from getting into the drive unit 260.

As previously discussed, the implementation of a conductive strip 290 located on the voice coil former 250 allows the stiffening element 280 to be fitted closer to the voice coil former 250. This is possible because the conductive strip 290 can be thinner than the wires used to electrically connect the lead wire 270 and the voice coil 240 in conventional loudspeakers (for example as discussed above for FIG. 3).

By fitting the stiffening element 280 closer to the voice coil former 250, the likelihood of glue dripping down into the magnet assembly when the stiffening element 280 is glued to voice coil former 250 can be reduced. Moreover, by removing the necessity to run wires between the voice coil former 250 and the stiffening element 280 the likelihood of damaging the insulation surrounding such wires is reduced when the stiffening element 280 is slid over the voice coil former 250 in production.

The conductive strip 290 may protrude less than 0.5 mm from the surface of the voice coil former. More preferably the conductive strip 290 protrudes less than 0.3 mm, or more preferably less than 0.1 mm from the surface of the voice coil former. For example, the conductive strip 290 may be made from a metal foil, such as copper foil, which is glued to the surface of the voice coil former 250 using a thermosetting glue.

In these examples, an outlet wire 242 of the voice coil 240 and the lead wire 270 are soldered to the first 292 and second 294 landing surfaces respectively. The presence of separate landing surfaces helps to facilitate different solder methods and materials to be used to create each of the solder joints. Accordingly, the voice coil 240 may be made from any conductive metal wire such as copper, aluminium, or copper clad aluminium.

Moreover, having separate landing surfaces for each electrical connection can aid with assembly of the loudspeaker 200. For example, when the voice coil 240 is soldered to the first landing surface 292 on the conductive strip 290 the lead wire 270 can then also be soldered to the second landing surface on the conductive strip 290 at a later time without risking de-soldering of the first solder connection between the voice coil and the conductive strip 290.

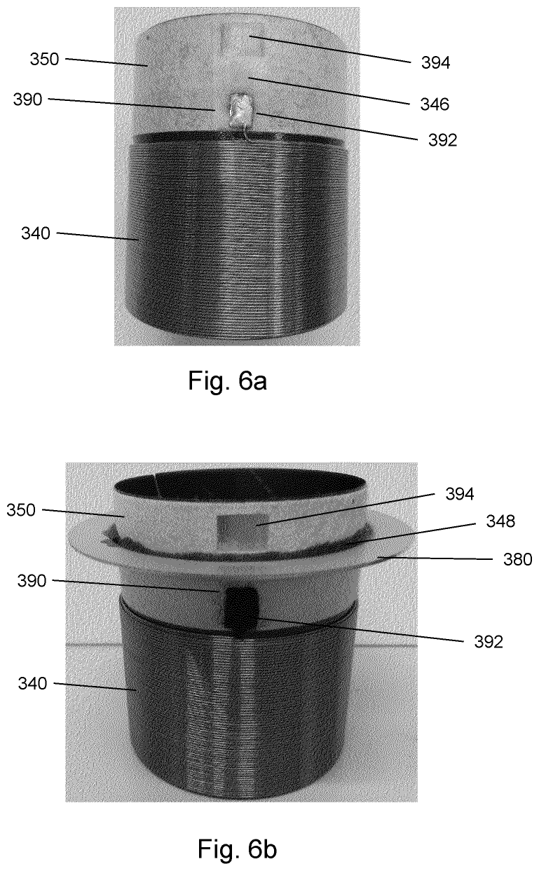

FIG. 6a shows a photograph of a voice coil 340, and voice coil former 350 according to the present invention and FIG. 6b shows a photograph of the voice coil 340, and voice coil former 350 of FIG. 6b with a stiffening element attached according to the present invention.

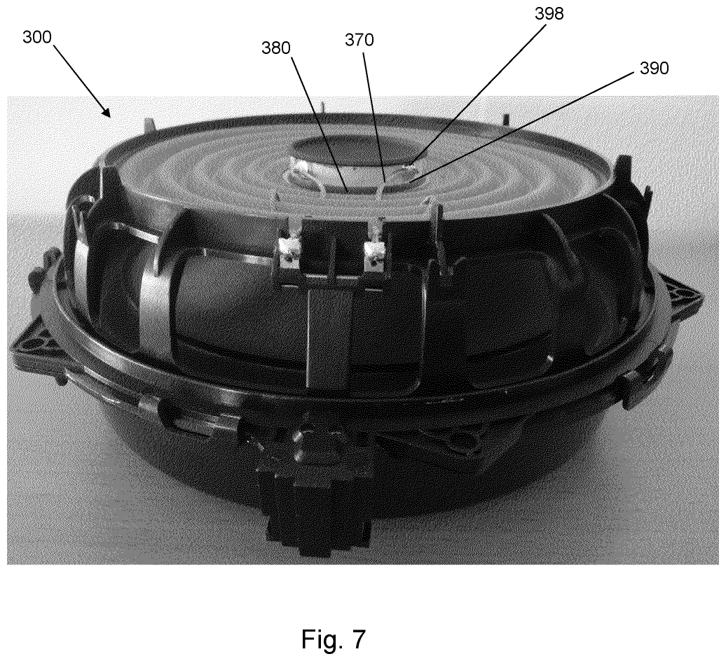

FIG. 7 shows a photograph of a loudspeaker 300 according to the present invention.

In these examples, an insulating paper 346 partially covers the conductive strip 390 to prevent the stiffening element 380 from short-circuiting the voice coil 340. The implementation of the thin conductive strip 390 in place of wires can reduce the likelihood of water ingress between the insulating paper 346 and the voice coil former 350 in open air applications. This is discussed in more detail below.

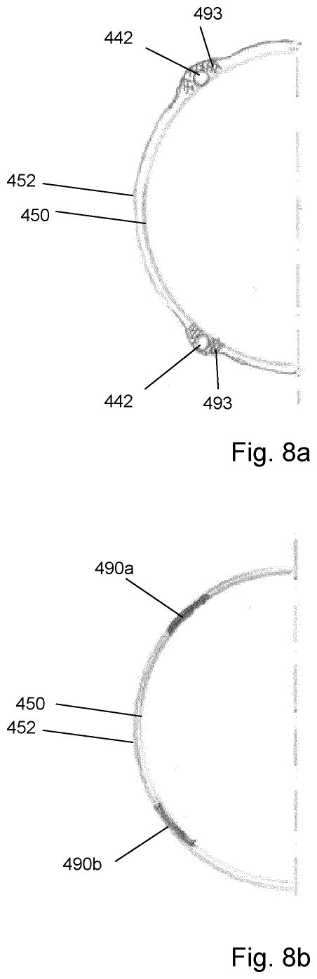

FIG. 8a shows a top view of a voice coil former 450 of a conventional loudspeaker where an insulating paper 452 covers outlet wires 442 of the voice coil. Open channels 493 surrounding the outlet wires 442 are present between the insulating paper 452 and the voice coil former 450 as discussed previously for FIG. 4c. These open channels 493 can allow water to penetrate the loudspeaker via capillary action.

By comparison, FIG. 8b shows a top view of a voice coil former 450 according to the present invention which has first 490a and second 490b conductive strips located on the radially outer surface of the voice coil former 450. An insulating paper 452 covers the first 490a and second 490b conductive strips. The first 490a and second 490b conductive strips are significantly thinner than the wires used in conventional loudspeakers allowing the insulating paper 452 to be more closely fitted over the voice coil former 450 around the first 490a and second 490b conductive strips.

The present inventor has observed that this results in a loudspeaker which performs better than conventional loudspeakers at preventing water penetration. Furthermore, the likelihood of corrosion to aluminium or copper clad aluminium wire which may preferably be used to make the voice coil windings is reduced since the voice coil and outlet wires of the voice coil are less likely to get wet. Therefore, the loudspeaker can perform more reliably in open-air applications and the available range of materials which the voice coil may be made from is expanded.

In some examples, the outlet wire 240 of the voice coil 240 and the first landing surface 292 may be covered in an epoxy glue to further reduce the risk of corrosion to the winding wire when it is made from aluminium or copper clad aluminium.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.

WO2004017674

1. A loudspeaker comprising:
a chassis;
a diaphragm suspended from the chassis by one or more suspension elements;
a lead wire for supplying an electrical signal;
a drive unit configured to move the diaphragm along a translational axis based on the electrical signal, the drive unit comprising a magnet unit, a voice coil and a voice coil former; and
a stiffening element which is a rigid component configured to stiffen a portion of the diaphragm adjacent to the voice coil former;
wherein:
the stiffening element fits around the voice coil former and extends radially outwardly from the voice coil former with respect to the translational axis;
the voice coil former includes a conductive strip for conducting the electrical signal from the lead wire to the voice coil; and
the voice coil is electrically connected to the conductive strip via a first landing surface on the conductive strip, and the lead wire is electrically connected to the conductive strip via a second landing surface on the conductive strip, wherein the first and second landing surfaces are located on opposite sides of the stiffening element with respect to the translational axis.

2. The loudspeaker of claim 1, wherein the conductive strip has a width in a circumferential direction relative to the translational axis that is larger than a thickness in a radial direction relative to the translational axis.

3. The loudspeaker of claim 1, wherein the conductive strip protrudes less than 0.5 mm from a radially outwardly facing surface of the voice coil former.

4. The loudspeaker of claim 1, wherein the distance between an outer surface of the voice coil former and an inner surface of the stiffening element is, at its largest extent, no more than 0.5 mm.

5. The loudspeaker of any preceding claim 1, wherein the distance between the first landing surface and the second landing surface along the translational axis is at least 20% of the total height of the voice coil former.

6. The loudspeaker of claim 1, wherein an outlet wire of the voice coil is soldered to the first landing surface of the conductive strip and the lead wire is soldered to the second landing surface of the conductive strip.

7. The loudspeaker of claim 6, wherein the outlet wire of the voice coil is soldered to the first landing surface with a first solder material and the lead wire is soldered to the second landing surface with a second solder material.

8. The loudspeaker of claim 1, wherein the conductive strip is made of a conductive foil.

9. The loudspeaker of claim 1, wherein the conductive strip is glued to the voice coil former.

10. The loudspeaker of claim 1, wherein a region of the conductive strip between the first and second landing surfaces is covered by an insulating material.

11. The loudspeaker of claim 1, wherein the voice coil is made from one of copper, copper clad aluminium or aluminium.

12. The loudspeaker of claim 1, wherein the stiffening element is made from an anodized metal.

13. The loudspeaker of any preceding claim 1, wherein:
the lead wire is a first lead wire for supplying a first electrical signal and the conductive strip is a first conductive strip for conducting the first electrical signal to the voice coil; and
the loudspeaker further comprises a second lead wire for supplying a second electrical signal and the voice coil former includes a second conductive strip for conducting the second electrical signal to the voice coil;
wherein the voice coil is electrically connected to the second conductive strip via a first landing surface on the second conductive strip, and the second lead wire is electrically connected to the second conductive strip via a second landing surface on the second conductive strip, wherein the first and second landing surfaces of the second conductive strip are located on opposite sides of the stiffening element with respect to the translational axis

14. A method of forming the loudspeaker of claim 1 comprising:
electrically connecting the voice coil to the first landing surface of the conductive strip;
sliding the stiffening element over the voice coil former;
attaching the stiffening element to the diaphragm and voice coil former; and
attaching the lead wire to the second landing surface of the conductive strip;
wherein the stiffening element is attached to the voice coil former at a location along the translational axis that is between the first and second landing surfaces.

15. The method of claim 14, wherein the step of electrically connecting the voice coil to the first landing surface comprises soldering an outlet wire from the voice coil to the first landing surface using a first solder material and the step of attaching the lead wire to the second landing surface comprises soldering the lead wire to the second landing surface using a second solder material.
